(19) United States
(12) Patent Application Publication
(10) Pub. No.: US 2010/0088226 A1
(43) Pub. Date: Apr. 8, 2010

(54) System and Method to Facilitate Charitable Giving

(76) Inventor: Robert L. Alexander, SR., Mitchellville, MD (US)

Correspondence Address: WHITEFORD, TAYLOR & PRESTON, LLP;ATTN: GREGORY M STONE, SEVEN SAINT PAUL STREET, BALTIMORE, MD, 21202-1626, US

(21) Appl. No.: 12/529,431

(22) PCT Filed: Feb. 29, 2008
(86) PCT No.: PCT/US08/02686

§ 371 Date: Sep. 1, 2009

Related U.S. Application Data
(60) Provisional application No. 60/904,331, filed on Mar. 1, 2007.
(60) Provisional application No. 60/920,532, filed on Mar. 28, 2007.

(51) Int. Cl. G06Q 20/00; G06Q 50/00; H04M 1/64

(52) U.S. Cl. 705/39; 705/329; 379/88.22

(57) ABSTRACT

The invention comprises a process, design, and conceptualization of a global philanthropic fundraising effort, centered around a special day of recognition for each individual citizen in the USA and worldwide. The funds derived from pledges are to be used for charitable giving for such needs as Global AIDS and World Hunger. The invention enables a website and toll-free phone system that allows an individual to highlight the recognition of a person's special celebration with a nominal gift of giving back to the less fortunate and those in the world who are in most desperate need by making a monetary pledge to a charitable organization. In return, the pledge person or designated recipient will receive a personalized E-GRAM or recorded telephone call from an important, nationally or internationally known, celebrity.

### TECHNICAL FIELD

The invention comprises a global philanthropic fundraising system, centered around the birthday of each individual citizen in the United States and worldwide. The system and method are used to derive funds from birthday pledges so that such funds can be used for philanthropic purposes, such as Global AIDS research and eradication and World Hunger projects.

### BACKGROUND ART

There are 300 million Americans and 6 billion persons in the world today, all of whom have a birthday. Each day, nearly 800,000 Americans have a birthday and 16.5 million persons worldwide. This invention enables a website and toll-free phone system that allows an individual to highlight the recognition of a person's birthday celebration with a nominal gift of giving back to the less fortunate and those in the world who are in most desperate need by making a monetary pledge to a charitable organization. In return, the pledge person or designated recipient will receive a birthday E-GRAM or recorded telephone call from an important, nationally or internationally known celebrity.

### DISCLOSURE OF INVENTION

The invention comprises an Internet website on the worldwide web, which may be named www.mybirthdaypledge.com. Additional names may be reserved for other top-level domains, such as .net and .org. This process may also be operated by telephone for individuals wishing to pledge a donation by dialing a toll-free phone number such as 1-866-99PLEDGE. Other numbers, which may or may not be toll free, may be used.

### BEST MODE(S) FOR CARRYING OUT THE INVENTION

In a first embodiment, the invention comprises a global website and CALL CENTER where everyday the birthday of millions can be celebrated. This idea was conceived on the anniversary of Dr. Martin Luther King's Birthday, upon the realization and significance that a birthday, emanating from the gift of giving, could mean so much to a people and a nation—for a cause. This, therefore, gave rise to the vision and creation of the herein described birthday pledge project for World Hunger and Global AIDS, the most worthy of all causes in the world.

This is a 21^{st} Century Global Fundraising Initiative for World Hunger and Global AIDS—which may best be described as, a global fundraising vehicle fueled with endless possibilities, because it is designed to highlight the recognition of each person's birthday celebration with a nominal gift of giving back to the less fortunate and those in the world who are in most desperate need. Hence, each person is invited to share his/her birthday with the gift of giving, and the invite list includes 300 million Americans (with over 800,000 birthdays celebrated daily in the U.S.) to start with a kick off website, mybirthdaypledge.org/us and a CALL CENTER number, 1-866-99PLEDGE. The program is designed to immediately expand the website(s) to include the 6 billion people on Planet Earth with global Internet website expansion for all industrialized nations of the United Nations, such as mybirthdaypledge.org/japan.

The ravages of World Hunger and Global AIDS have devastated the planet. The generosity of each individual celebrating his/her birthday with the gift of giving to World Hunger and/or Global AIDS is the conceptual theme, mission, and mandate of this global philanthropic fundraising effort. The process is narrowly defined and quite simple. There are 300 million Americans and 6 billion persons in the world today, all of whom have a birthday. Each day, nearly 800,000 Americans have a birthday and 16.5 million persons worldwide.

The concept is ambitious, practical and designed to immediately generate immeasurable revenue pledges to be made on each individual's birthday recognition in the U.S. and throughout the industrial world—by establishing a global website and CALL CENTER where everyday we celebrate the birthday of millions. The program is expected to be a success, because it is tied to the very soul of mankind—the individual's birthday! Moreover, all employers comprising the global workforce partnership initiative will be targeted/invited to participate; including major corporations, small businesses, federal, state and local governments in the U.S. and around the world—to use this as a vehicle to recognize and demonstrate employee birthday appreciation, as an act of social consciousness and staff motivation. The birthday E-GRAM and flowers, etc. are expected to serve as a big boost and motivation to employee morale, when coming from the employer who thought of them.

For many, the celebration or mere recognition of their birthday is significant to the individual. The conceptual process and design of this intellectual property presents via website or 1 800 CALL CENTER for individuals to celebrate their birthdays with the gift of giving—by donating a minimal sum to be established to:

1. Global AIDS and/or

2. World Hunger and Homelessness

3. Other charity of their choice.

Each participant pledge will receive a birthday E-GRAM from an important, nationally and internationally known “central personality”. The concept initially calls for the recruitment of former Presidents Bill Clinton, George Bush, Sr., and/or Jimmy Carter, which is in keeping with their existing global relief efforts. In the alternative, the process calls for other political leaders, celebrities or publicly well-known personalities to narrate the voice mail on the website with video and to narrate the voice mail of the 1 800 CALL CENTER line, expressing “HAPPY BIRTHDAY” to callers wishing to pledge a donation on their birthdays, or someone else (family, friends and business employers) wishing to celebrate with a pledge for a significant other's birthday.

Extensive, free media coverage, translated into free advertising, is expected due to the global significance of one's birthday shared in common by all on Planet Earth, plus the attraction of global personalities such as former presidents, dignitaries and celebrities, outlined in the attached. In this respect, media outlets including all TV, cable and satellite radio will be invited to participate by including periodically in their daily broadcasts: “A happy birthday shout-out to millions of their viewers/listeners. POWER UP with the celebration of your birthday today with the gift of giving. Let's eradicate the ravages of world hunger and global AIDS—log on to mybirthdaypledge.org or call 1-800-99PLEDGE to celebrate your birthday today with a generous pledge. Happy Birthday!

The following further outlines or delineates the process:

### Brief VOICE MAIL Recording:

“Hi, this is President ______ and this is President ______. We wish you a Happy Birthday!” Thank you for celebrating your birthday with the gift of giving! Join the race to save the human race—celebrate your [Happy Birthday] with friends and family by giving, not receiving. Pledge $5.00 or any sum appreciated on your birthday or the birthday of a friend, loved one, classmate, coworker, or employer by simply following the prompts:
Press ONE to pledge to World Hunger.
Press TWO to pledge to Global AIDS.
Press THREE for a Happy Birthday E-GRAM or postcard.
Press FOUR for Flowers Express (for a selection of birthday gifts with overnight delivery option).

A major credit card or debit card may be required to pledge on-line at the website www.mybirthdaypledge.org or by calling: 1-866-99 PLEDGE. In a preferred embodiment, donated proceeds will go to existing relief efforts and organizations to be determined. The website should be designed to include HTML print out text on screen for hearing impaired. Separate from the non-profit fundraising relief effort, plans call for limited advertising on the website and call center, limited to one or two vendors to offer callers the convenience of ordering flowers and related birthday presents.

### Detailed VOICE MAIL Recording:

This global fundraising initiative is expected to receive free press and media attention/interest. Enormous media attention will be further generated by spearheading this fundraiser with the recruitment of such global personalities as former Presidents Bill Clinton and George Herbert Walker Bush, both of whom reached new heights of global celebrity status arising from their joint efforts toward Tsunami Disaster Relief.

In a first embodiment of the Internet website and CALL CENTER, the invention may include a joint presentation by Presidents Bush and Clinton, briefly as follows. Their opening remarks could include: BUSH: Happy Birthday! I am President George Herbert Walker Bush—POWER UP with birthday joy, excitement and thanksgiving! CLINTON: . . . and I'm President Bill Clinton. Thank you for celebrating your special birthday with the gift of giving to those less fortunate and in desperate need for assistance in the world. Let's agree to eradicate the ravages of World Hunger and Global AIDS on the Planet! BUSH: Join the race to save the human race—celebrate your [Happy Birthday] with friends, family, loved ones, and associates by giving. Pledge $5.00 or any sum will be appreciated on your birthday or the birthday of a friend, family member, loved one, classmate, co-worker and employer by simply following the prompts. CLINTON: President Bush and I appreciate your generous pledge and we wish you a happy, happy birthday and many, many more!

In a further embodiment, the fundraising may include such other global personalities as Super Bowl Champion Coach Tony Dungy and Super Bowl MVP Peyton Manning; followed by other combinations of celebrities, such as former President Jimmy Carter and Oprah Winfrey, and UN Secretary General Sg Ban Ki-Moon paired with a selected world leader/celebrity. The process will continue to evolve.

Furthermore, while the invention has been described as a birthday recognition pledge system, the same process can be used for any special day, such as a wedding anniversary, graduation day, or any other day to recognize someone. Appropriate Internet websites can be established using domain names such as: myspecialday.com; myanniversary.com; graduationday.com; and the like. Other top-level domains, such as .net or .org can also be used.

What is claimed is:

1. A method of facilitating charitable giving, said method comprising the steps of:
providing a centralized service enabled for communication with a user;
enabling said user to make a contribution to a designated charitable organization;
enabling said user to designate an individual for recognition by said centralized service;
said centralized service accepting payment for said designated charitable organization; and
said centralized service sending a recognition message to said designated individual.

2. The method according to claim 1 wherein said designated individual is recognized for an event selected from the group consisting of:
birthday;
anniversary;
graduation;
promotion; and
special event.

3. The method according to claim 1 wherein said recognition message comprises a message from a celebrity or nationally and/or internationally known personality.

4. The method according to claim 2 wherein said recognition messaging is at least one of:
email;
phone message;
letter; or
card.

5. The method according to claim 2 wherein said recognition messaging is pre-recorded.

6. The method according to claim 1 wherein said centralized service further comprises an Internet website.

7. The method according to claim 1 wherein said centralized service further comprises a telephone reception service.

8. The method according to claim 1 wherein said contribution is made by credit card or debit card.

9. The method according to claim 1, further comprising the steps of:
said centralized service forwarding said contribution to said designated charitable organization.

10. The method according to claim 1, further comprising the steps of:
said centralized service sending at least one additional item to said designated individual at the request of said user.

11. The method according to claim 10 wherein the addition item is one of flowers or gifts.
